(19) United States
(12) Patent Application Publication
(10) Pub. No.: US 2019/0013618 A1
(43) Pub. Date: Jan. 10, 2019

(54) PLUG CONNECTOR

(71) Applicant: ROSENBERGER HOCHFREQUENZTECHNIK GMBH & CO. KG, Fridolfing (DE)

(72) Inventors: Anne Barbet, Burghausen (DE); Josef Krautenbacher, Fridolfing (DE); Tobias Stadler, Fridolfing (DE); Martin Wimmer, Palling (DE)

(21) Appl. No.: 16/070,077

(22) PCT Filed: Jan. 31, 2017
(86) PCT No.: PCT/EP2017/000119

§ 371 Date: Jul. 13, 2018

(30) Foreign Application Priority Data
Feb. 5, 2016 (DE) 16 000 297.8

(51) Int. Cl. H01R 13/627; H01R 24/40; G02B 6/38

(52) U.S. Cl. CPC H01R 13/6277; H01R 2103/00; G02B 6/3893; H01R 24/40

(57) ABSTRACT

A plug connector having a first connector and a second connector, connected by a joining movement along an axis of main extent of the plug connector, wherein a securing element associated with the first connector can be shifted between a locking position (A) and an unlocking position (B) along the axis of main extent, a fixing element can be deflected in the radial direction (III), and wherein the fixing element can be released by a movement in the radial direction (III) by shifting the securing element out of the locking position (A) to the unlocking position (B). In the locking position (A), the securing element is designed so as to permit the fixing element to move in the radial direction (III) in order to allow a joining movement in the axial direction (I) for connecting the first connector to the second connector.

### BACKGROUND OF THE INVENTION

### 1. Field of the Invention

The invention relates to a plug connector. The invention further relates to a first connector and a second connector for such a plug connector as well as a satellite equipped with such a plug connector.

### 2. Description of Related Art

Plug connectors are used to isolate and connect components such as circuit boards and/or cables for electrical or optical signals, for example electrical current or optical radiation, for example light or laser light.

Plug connectors consist of at least two parts, a male part and a female part.

The male part of a plugged connection has outward-pointing contact tongues, while the female part has inward-pointing contact openings. However, there are also plug connectors with plug elements of both genders.

The male part is also referred to as a plug, if it is attached at the ends of a cable, or as an adapter.

The female part is also referred to as a coupling, if it is attached at the ends of a cable, or as a socket, if it is built rigidly into a device housing.

For example, so-called SMP plug connectors, which as the name suggests are plugged together, are used for electrical high frequency (RF) signals with a frequency of up to 40 GHz. Such plug connectors guarantee a connection up to a maximum tensile force of approximately 22 N to 68 N. In the event of higher tensile forces occurring, the connection is disconnected.

In order to prevent an undesired disconnection under higher tensile forces, a coaxial plug connector with a securing sleeve is known from DE 44 39 852 A1 which can be moved between two end positions in the axial direction of the plug connector. By displacing the securing sleeve in the direction of the free end of the plug, fixing elements can be moved radially inwards and fixed, wherein in this fixed position the plug can then be held in the socket in engagement with counter-fixing elements. By moving the securing sleeve in the opposite direction, i.e., away from the free ends, the engagement of the fixing elements with the counter-fixing elements can be released, so that the plug can be separated from the socket with a low application of force.

However, the coaxial plug connector known from DE 44 39 852 A1 demands that, in order to create a plugged connection, the securing sleeve is not located at the free ends, i.e., in order to form a connection, in a first step the securing sleeve needs to be moved, contrary to the joining movement, away from the free ends and then, in a second step, moved in the direction of the joining movement towards the free ends in order to connect the plug with the socket. This unnatural sequence of movement makes it more difficult to form a connection with such a plug connector.

### SUMMARY OF THE INVENTION

The invention is based on the problem of providing a plug connector in which the connection is reliably secured against increased tensile forces and which at the same time is easier to handle.

According to the invention this problem is solved through a plug connector of the aforementioned type with the features characterized in the independent claims. Advantageous embodiments of the invention are described further in the dependent claims.

The above and other objects, which will be apparent to those skilled in the art, are achieved in the present invention which is directed to a plug connector comprising a first connector and a second connector, wherein the first connector and the second connector can be connected through a joining movement along a main axis of extension of the plug connector, wherein a securing element which is associated with the first connector can be displaced along the main axis of extension between a locking position (A) and an unlocking position (B), wherein a fixing element is provided in order to fix the first connector to the second connector through interaction with a counter-fixing element in order to block a disconnecting movement, wherein the fixing element is moveable in a radial direction (III), wherein the securing element is, directly or indirectly, in operative connection with the fixing element, such that a displacement of the securing element from the locking position (A) into the unlocking position (B) causes a displacement of the fixing element at least in a radial direction (III), and wherein, by displacing the securing element from the locking position (A) into the unlocking position (B), the fixing element of the counter-fixing element can be released through a movement in a radial direction (III) in order to permit a disconnecting movement in an axial direction (II) in order to separate the first connector from the second connector, such that in the locking position (A) the securing element is designed to permit the fixing element a movement in a radial direction (III) in order to make possible a joining movement in an axial direction (I) in order to connect the first connector with the second connector.

In the locking position (A) the fixing element may be moved by a first travel length (L1), at least in a radial direction (III), and by displacing the securing element from the locking position (A) into the unlocking position (B) the fixing element can be displaced in a radial direction (III) by a second travel length (L2), wherein the second travel length (L2) is greater than the first travel length (L1).

The fixing element may include a snap-in hook and the counter-fixing element has a counter-snap-in hook designed to interact with the snap-in hook in order to form a snap-locking connection.

A first insertion region and a second insertion region are provided, wherein the second insertion region is designed such that, through interaction with the first insertion region, this causes the movement of the fixing element in a radial direction (III), wherein, in particular, the first insertion region is associated with the first connector and the second insertion region is associated with the second connector.

The securing element and/or the fixing element may be manufactured from an electrically conductive material. The securing element may be connected with an outer conductor of the plug connector in an electrically conductive manner via at least one shield contact element.

The plug connector may further include a withdrawal bevel which is at least partially in operative connection with the securing element is provided which, through interaction with a withdrawal contact surface, causes the movement of the fixing element in the direction of the third direction (III). The withdrawal bevel and the withdrawal contact surface may be associated with the first connector.

The withdrawal bevel may be formed on the fixing element, or the withdrawal contact surface may be formed on the securing element.

The securing element can be connected undetachably with a main plug body of the first connector. The securing element may further comprise a securing sleeve.

In a second aspect, the present invention is directed to a first connector for a plug connector comprising: a joining movement connecting the first connector to a second connector along a main axis of extension of the plug connector; a securing element which is associated with the first connector displaced along the main axis of extension between a locking position (A) and an unlocking position (B); and a fixing element fixing the first connector to the second connector through interaction with a counter-fixing element in order to block a disconnecting movement; wherein the fixing element is moveable in a radial direction (III); wherein the securing element is, directly or indirectly, in operative connection with the fixing element, such that a displacement of the securing element from the locking position (A) into the unlocking position (B) causes a displacement of the fixing element at least in a radial direction (III), and wherein, by displacing the securing element from the locking position (A) into the unlocking position (B), the fixing element of the counter-fixing element can be released through a movement in a radial direction (III) in order to permit a disconnecting movement in an axial direction (II) in order to separate the first connector from the second connector, such that in the locking position (A) the securing element is designed to permit the fixing element a movement in a radial direction (III) in order to make possible a joining movement in an axial direction (I) in order to connect the first connector with the second connector.

In a third aspect, the present invention is directed to a second connector for a plug connector comprising: a joining movement connecting the second connector to a first connector along a main axis of extension of the plug connector; a securing element associated with the first connector displaceable along the main axis of extension between a locking position (A) and an unlocking position (B); and a fixing element fixing the second connector to the first connector through interaction with a counter-fixing element in order to block a disconnecting movement; wherein the fixing element is moveable in a radial direction (III); wherein the securing element is, directly or indirectly, in operative connection with the fixing element, such that a displacement of the securing element from the locking position (A) into the unlocking position (B) causes a displacement of the fixing element at least in a radial direction (III), and wherein, by displacing the securing element from the locking position (A) into the unlocking position (B), the fixing element of the counter-fixing element can be released through a movement in a radial direction (III) in order to permit a disconnecting movement in an axial direction (II) in order to separate the first connector from the second connector, such that in the locking position (A) the securing element is designed to permit the fixing element a movement in a radial direction (III) in order to make possible a joining movement in an axial direction (I) in order to connect the first connector with the second connector.

In a fourth aspect, the present invention is directed to a satellite equipped with a plug connector, said plug connector comprising: a first connector and a second connector, wherein the first connector and the second connector can be connected through a joining movement along a main axis of extension of the plug connector, wherein a securing element which is associated with the first connector can be displaced along the main axis of extension between a locking position (A) and an unlocking position (B), wherein a fixing element is provided in order to fix the first connector to the second connector through interaction with a counter-fixing element in order to block a disconnecting movement, wherein the fixing element is moveable in a radial direction (III), wherein the securing element is, directly or indirectly, in operative connection with the fixing element, such that a displacement of the securing element from the locking position (A) into the unlocking position (B) causes a displacement of the fixing element at least in a radial direction (III), and wherein, by displacing the securing element from the locking position (A) into the unlocking position (B), the fixing element of the counter-fixing element can be released through a movement in a radial direction (III) in order to permit a disconnecting movement in an axial direction (II) in order to separate the first connector from the second connector, such that in the locking position (A) the securing element is designed to permit the fixing element a movement in a radial direction (III) in order to make possible a joining movement in an axial direction (I) in order to connect the first connector with the second connector.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 shows a schematic sectional view through a plug connector, consisting of a first connector and a second connector, according to an exemplary embodiment of the invention in the unconnected state;

FIG. 2 shows a perspective sectional view of the first connector shown in FIG. 1;

FIG. 3 shows a first step in the assembly of the plug connector shown in FIG. 1;

FIG. 4 shows a second step in the assembly of the plug connector shown in FIG. 1;

FIG. 5 shows a third step in the assembly of the plug connector shown in FIG. 1;

FIG. 6 shows a fourth step in the assembly of the plug connector shown in FIG. 1;

FIG. 7 shows a fifth and final step in the assembly of the plug connector shown in FIG. 1; and

FIG. 8 shows the unlocking of the plug connector shown in FIG. 1 for the purpose of disconnection.

### DESCRIPTION OF THE PREFERRED EMBODIMENT(S)

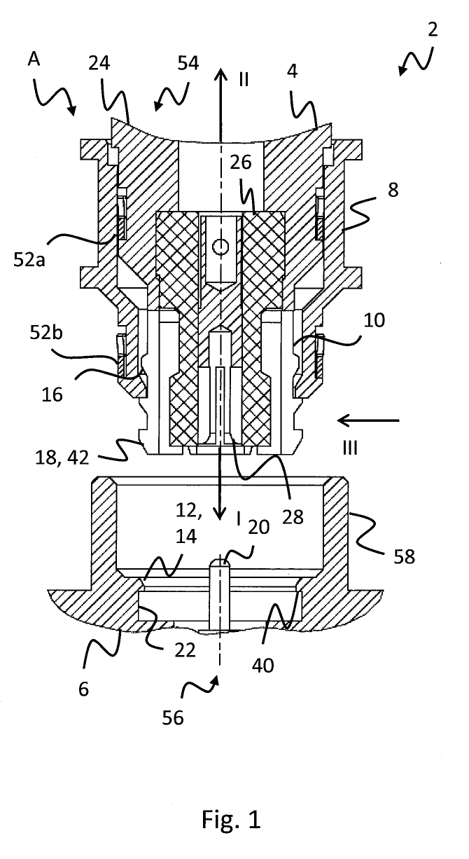

In describing the preferred embodiment of the present invention, reference will be made herein to FIGS. 1-8 of the drawings in which like numerals refer to like features of the invention.

For this purpose, according to the invention, in a plug connector of the aforementioned type it is provided that, in the locking position, the securing element is designed to permit a movement of the fixing element in a radial direction in order to make possible a joining movement in the axial direction in order to connect the first connector with the second connector.

The first connector can thereby be a plug and the second connector a socket, or the first connector is designed as a socket and the second connector is designed as a plug.

This has the advantage that the first connector can also be connected with the second connector through the joining movement in the locking position. It is thus not necessary, before performing the joining movement, first to move the securing element in a direction contrary to the direction of the joining movement; instead, the first connector can be connected with the second connector immediately, in one step. This greatly simplifies the creation of a connection with the plug connector, since the securing element can serve as a grip element during the joining procedure, thus making possible single-handed assembly. At the same time, the plug connector, which has a release function, can be equipped with fixing elements which maintain a connection of the first connector with the second connector even under the application of high tensile forces, for example above 22 to 68 N, since due to the securing element having an unlocking effect the holding force between the first connector and the second connector can be reduced if necessary in order to separate them from one another.

The plug connector can be designed for the transmission of electricity, for example electrical signals or supply voltages. Alternatively, the plug connector can also be designed for the transmission of optical signals, for example light or laser light signals, and serve to connect two optical waveguides, for example. The plug connector can be designed as a coaxial plug connector with an outer contact and an inner contact. Alternatively however, the plug connector can also have other forms or plug contact arrangements, for example with a plurality of contacts which are arranged in a row or in a rectangular form, wherein the outer conductor can be active or non-active. Furthermore, the plug connector can be designed as an SMP plug connector for the transmission of RF signals with frequencies of up to 40 GHz.

Also, the locking position can be located at the free end of the first connector facing the second connector and the unlocking position can be located at the end facing away from the second connector. The securing element can be, directly or indirectly, in operative connection with the fixing element, i.e., without the interposition of construction elements or with interposition of construction elements. In operative connection should be understood to mean that the securing element and the fixing element are, directly or indirectly, at least partially or temporarily in contact, or not in contact, depending on their positions between the locking position and unlocking position. Furthermore, the radial direction extends at a right angle to the main axis of extension of the plug connector, irrespective of whether the plug connector itself is rotationally symmetrical in design.

According to one embodiment, in the locking position the fixing element can be moved by a first travel length at least in a radial direction, and by displacing the securing element the fixing element can be moved from the locking position into the unlocking position in a radial direction by a second travel length, wherein the second travel length is greater than the first travel length. In this way it is ensured that in the unlocking position the fixing elements are at a greater distance from counter-fixing elements than in the locking position, so that a reliable separation of the first connector from the second connector is guaranteed.

According to a further embodiment, the fixing element has a snap-in hook and the counter-fixing element has a counter-snap-in hook configured to interact with the snap-in hook in order to form a snap-locking connection. In this way, a connection of the first connector with the second connector can also be maintained under the application of high tensile forces, for example above 22 to 68 N. Instead of a snap-locking connection, the fixing element and the counter-fixing element can also be designed to form a clamped connection or to form other force-locking and/or form-locking connections.

According to a further embodiment, a first insertion region and a second insertion region are provided, wherein the first insertion region, for example a socket insertion bevel, causes the movement of the fixing element in a radial direction through interaction with the second insertion region. When the first connector is joined together with the second connector, the first insertion region and the second insertion region thus cause the fixing element, for example the snap-in hook, to be deflected and thus be able to enter into engagement with the counter-fixing element, designed for example as a counter-snap-in hook. In this way, the plug connector can have a particularly simple structure.

According to a further embodiment, the second insertion region is assigned to the plug, and the first insertion region is assigned to the socket. In this way, a pre-centering of the plug is effected at the same time when introducing the plug into the socket.

According to a further embodiment, the securing element and/or the fixing element are manufactured from an electrically conductive material. This means that the securing element can in addition take on the function of an EMC shielding, while at the same time the fixing element forms an outer conductor section, for example of a coaxial plug connector. Thus, the securing element and/or the fixing element each perform a double function.

According to a further embodiment, the securing element is connected with an outer conductor of the plug connector in an electrically conductive manner via at least one shield contact element. As a result, shielding losses are compensated due to the slotted design of the fixing element. In this way, the RF shielding is improved.

According to a further embodiment, a withdrawal bevel which is at least partially in operative connection with the securing element is provided which causes the movement of the fixing element in the direction of the third, in particular radial, direction through interaction with a withdrawal contact surface. Thus, on displacement of the securing element, the withdrawal bevel has the effect that the fixing element, for example the snap-in hook, is deflected and brought out of engagement with the counter-fixing element, designed for example as a counter-snap-in hook.

According to a further embodiment, the withdrawal bevel and the withdrawal contact surface are assigned to the first connector. Thus, the unlocking effect of the securing element is independent of the second connector, so that the first connector is suitable for different second connectors without losing its unlocking effect.

According to a further embodiment, the withdrawal bevel is formed on the fixing element. In this way, the fixing element can have a particularly simple single-part structure. The withdrawal bevel can be made of the same material as the fixing element, or the withdrawal bevel and the fixing element are made of different materials.

According to a further embodiment, the withdrawal contact surface is arranged on the securing element. In this way, the securing element can have a particularly simple single-part structure. The withdrawal contact surface can thereby be made of the same material as the securing element, or the withdrawal contact surface and the securing element are made of different materials.

According to a further embodiment, the securing element is connected undetachably with a main plug body of the first connector. For example, the securing element can be held undetachably in a guide of the main plug body between the locking and unlocking position. In this way, the securing elements are connected through a joining movement during formation of a connection without it being possible for the securing element to be lost or needing to be fitted beforehand.

According to a further embodiment, the securing element comprises a securing sleeve. In this way, the securing element can have a particularly simple single-part and uniform-material structure with for example contact tongues arranged spaced apart at regular radial intervals which are formed by material incuts in a cylinder and which are for example in each case provided with snap-in hooks at their free ends.

The invention also comprises such a first connector and such a second connector for a plug connector and a satellite equipped with such a plug connector. A satellite is thereby to be understood to mean an artificial satellite which circles a celestial body—a planet such as the earth or the moon—on an elliptical or circular orbit in order to fulfill scientific, commercial or military purposes.

Reference is first made to FIG. 1.

Illustrated is a plug connector 2 for the mutual electrical connection of two components, for example circuit boards and/or cables, for example of a satellite. However, the plug connector can also connect circuit boards and/or cables of other equipment with one another in an electrically conductive manner.

In the present exemplary embodiment the plug connector 2 is designed for the transmission of electrical signals, for example of RF signals, or for the transmission of supply voltages. Alternatively, the plug connector 2 can also be designed to transmit optical signals, for example light or laser light, and in this case connect optical components and/or optical waveguides with one another.

The plug connector 2 has a male part and a female part, whereby, irrespective of the connection partner of the male part and of the female part, for example circuit boards and/or cables, the male part is in the following referred to as the first connector 4 and the female part as the second connector 6. In the present exemplary embodiment, the first connector 4 is designed as a plug and the second connector 6 as a socket.

An electrically conductive connection or one transmitting optical signals can be formed with the plug connector 2 in that the first connector 4 is moved along its main axis of extension in a first, in the present exemplary embodiment axial direction I towards the second connector 6 and connected with this, as will be explained in detail later.

In the present exemplary embodiment, the plug connector 2 is designed as a coaxial plug connector with an elongated basic form in a main axis of extension and therefore has an inner conductor 56 and an outer conductor 54. In departure from the present exemplary embodiment, the plug connector 2 can also be of any other plug contact configuration, for example with contacts arranged in a row or in a rectangular form.

In the present exemplary embodiment, the first connector 4 has a main plug body 24, an insulating body 26, a securing element 8 and a fixing element 10 as well as an inner conductor plug socket 28.

Furthermore, in the present exemplary embodiment, in addition to a connection pin 20 for connection with the inner conductor plug socket 28, the second connector 6 has a counter-fixing element 12 for interaction with the fixing element 10, in order to fix the first connector 4 to the second connector 6. In the present exemplary embodiment, the fixing element 10 and the counter-fixing element 12 are designed to form a snap-locking connection. Alternatively, the fixing element 10 and the counter-fixing element 12 can also be designed to form a clamped connection.

Finally, the plug connector 2 has an RF shielding which in the present exemplary embodiment comprises a first shield contact element 52a and a second shield contact element 52b for RF shielding. The first shield contact element 52a is arranged between the main plug body 24 and the securing element 8 and extends in an annular manner around the main body 24, while the second shield contact element 52b is arranged between a main socket body 58 of the second connector 6 and the securing element 8 and extends in an annular manner around the securing element 8. Since the main plug body 24 and the main socket body 58 in each case form sections of the outer conductor 54, the first shield contact element 52a and the second shield contact element 52b are connected in an electrically conductive manner with the outer conductor 54.

The inner conductor 56 of the plug connector 2 is formed by the connection pin 20 of the second connector 6 and the inner conductor plug socket 28 of the first connector 4, while the outer conductor 54 is formed by an outer contact section 18 of the fixing element 10 of the first connector 4 and the mating contact section 22 of the second connector 6.

The insulating body 26, which insulates the inner conductor 56 and the outer conductor 54 electrically from one another, is arranged between the fixing element 10 and the inner conductor plug socket 28.

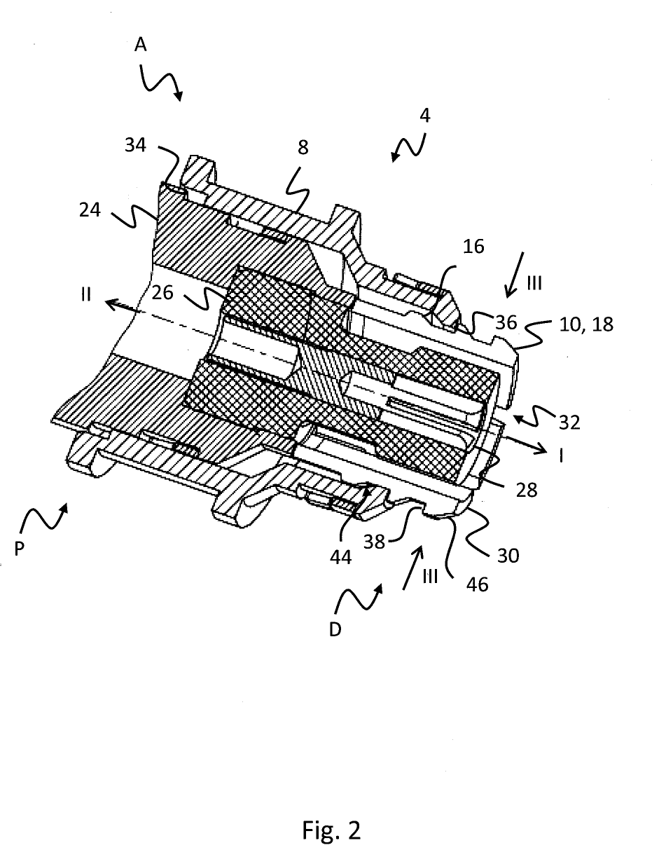

Further details, in particular of the securing element 8 and of the fixing element 10, are explained with additional reference to FIG. 2.

In the present exemplary embodiment, in distinction to the insulating body 26 the securing element 8 is manufactured of an electrically conductive material and is designed as a securing sleeve. In the present exemplary embodiment the securing element 8 can also be displaced undetachably within a guide of the main plug body 24 between a locking position A and an unlocking position B along the main axis of extension in the direction of the first direction I and the second direction II contrary to the first direction I. This movement is thereby limited by a first stop 34 and a second stop 36.

In the present exemplary embodiment, the locking position A is located at the front end D of the first connector 4, or the end facing the second connector 6, and the unlocking position B is located at the rear end P, or the end facing away from the second connector 6. In FIG. 2 the securing element 8 is located in the locking position A at the front end D.

In the present exemplary embodiment, the fixing element 10 is also manufactured from an electrically conductive material and has contact tongues 30 formed by a plurality of slits 32. In the present exemplary embodiment, the fixing element 10 is designed in the form of a sleeve, wherein the plurality of slits 32 is arranged spaced at regular intervals in the circumferential direction of the fixing element 10.

In the present exemplary embodiment, the fixing element 10 has a plurality of snap-in hooks 38 for forming the snap-locking connection with the counter-fixing elements 12 which are designed to interact with counter-snap-in hooks 40 of the second connector 6 (see FIG. 1). A deflection of the contact tongues 30 in a third, in the present exemplary embodiment radial direction III in order to form the snap-locking connection through engagement of the snap-in hooks 38 with the counter-snap-in hooks 40 is thereby guaranteed through the first insertion region 42, designed as an insertion contact surface, and the second insertion region 14 designed as a socket insertion bevel (see FIG. 1), which meet one another during a joining movement in the first direction I. For this purpose, in the present exemplary embodiment the first insertion region 42 and the second insertion region 14 are in each case designed in the form of a ramp.

In the present exemplary embodiment, the third direction III forms an angle of substantially 90° to the first direction I. The term “substantially” is understood to mean a range within usual manufacturing tolerances. Furthermore, in the present exemplary embodiment the first direction I and the second direction II extend along the main axis of extension of the plug connector 2, while the third direction III extends radially inwards due to the substantially rotationally symmetrical structure of the plug connector 2 as a coaxial plug connector.

In the present exemplary embodiment, the fixing element 10 also has a withdrawal bevel 16. As will be explained in detail later, when the securing element 8 is displaced from the locking position A into the unlocking position B, the withdrawal bevel 16 comes into contact with a withdrawal contact surface 44 of the securing element 8 as a result of a movement in the second direction II contrary to the first direction I and due to its ramp-formed design causes a deflection of the contact tongues 30 in the direction of the third, radial direction III.

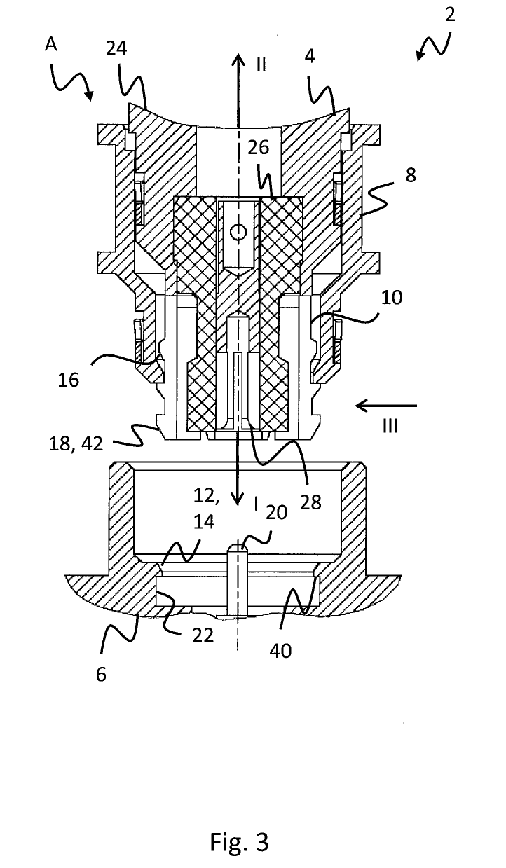

The assembly procedure for connecting the first connector 4 with the second connector 6 will now be explained with additional reference to FIGS. 3 to 8.

FIG. 3 shows a first step in which the first connector 4 and the second connector 6 are in the separated condition, wherein the first connector 4 is moved towards the second connector 6 through a joining movement in the first direction I. The securing element 8 can thereby serve as a grip element. The securing element 8 is hereby in the locking position A. In the locking position A the securing element 8 is located at the second stop 36. As a result, a relative movement of the securing element 8 in relation to the first connector 4 is prevented during the joining movement, so that the securing element 8 serves as a grip element during a single-handed assembly.

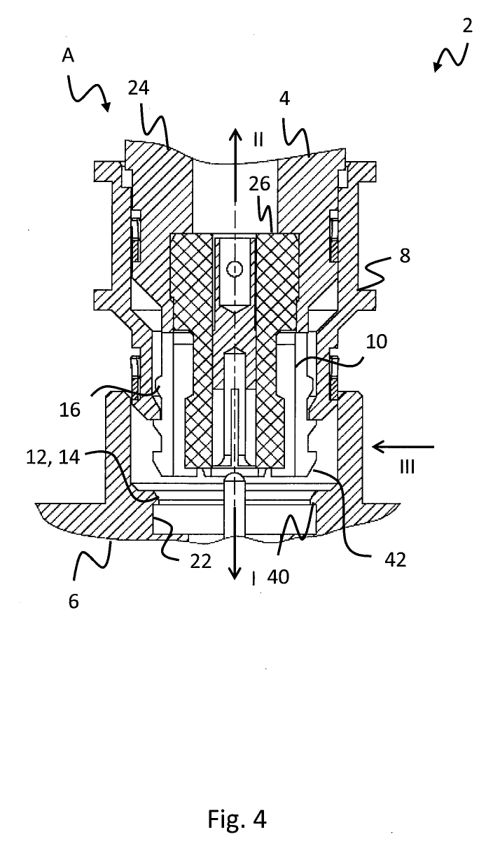

FIG. 4 shows a second step in which the first connector 4 is inserted so far into the second connector 6 through the joining movement in the first direction I that a first insertion region 42 of the fixing element 8 of the first connector 4 enters the second insertion region 14 of the second connector 6 and effects a pre-centering of the first connector 4 in the second connector 6.

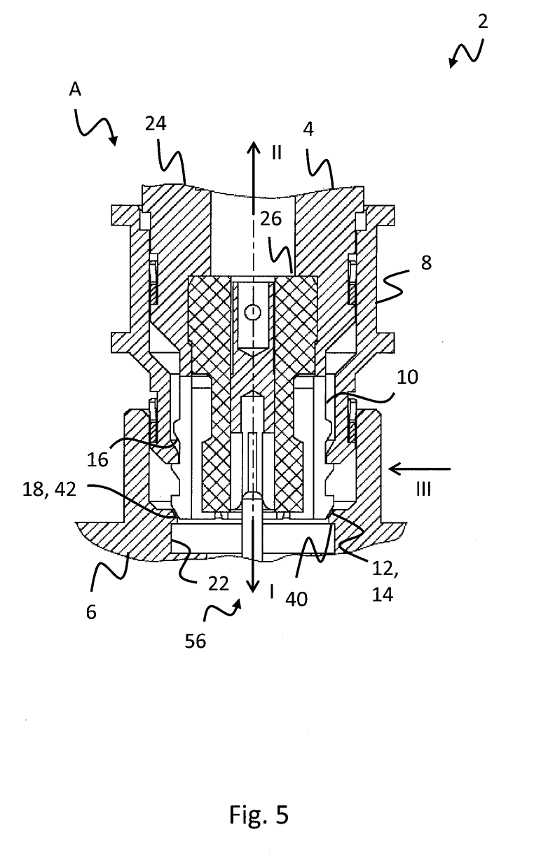

FIG. 5 shows a third step in which, through continuation of the joining movement in the first direction I, the plug insertion bevel 46 (see FIG. 2) of the fixing element 10 comes into contact with the second insertion region 14. At the same time the connection pin 20 (see FIG. 1) has entered into the inner conductor plug socket 28 (see FIG. 1), so that the inner conductor 56 is electrically connected.

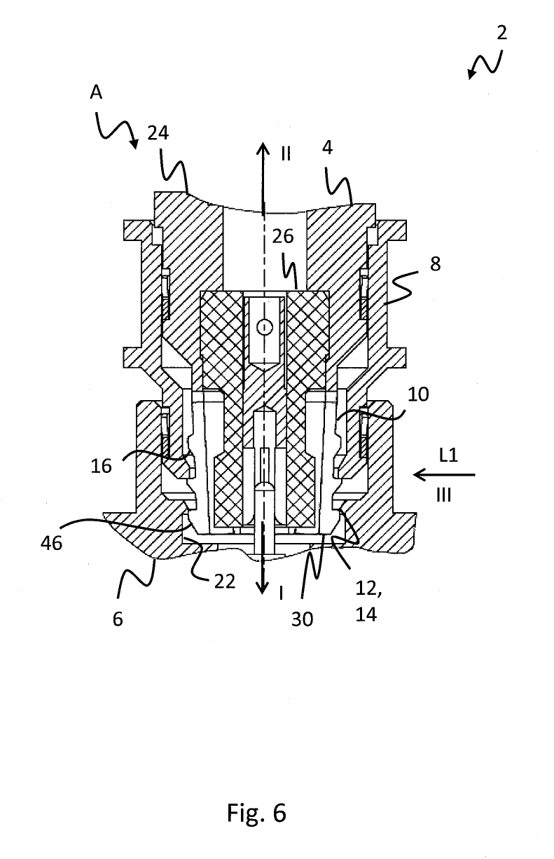

FIG. 6 shows a fourth step in which, through continuation of the joining movement in the first direction I, the contact tongues 30 are, through the ramp-formed design of the plug insertion bevel 46 and of the second insertion region 14, deflected by a first travel length L1 in the direction of the third direction III.

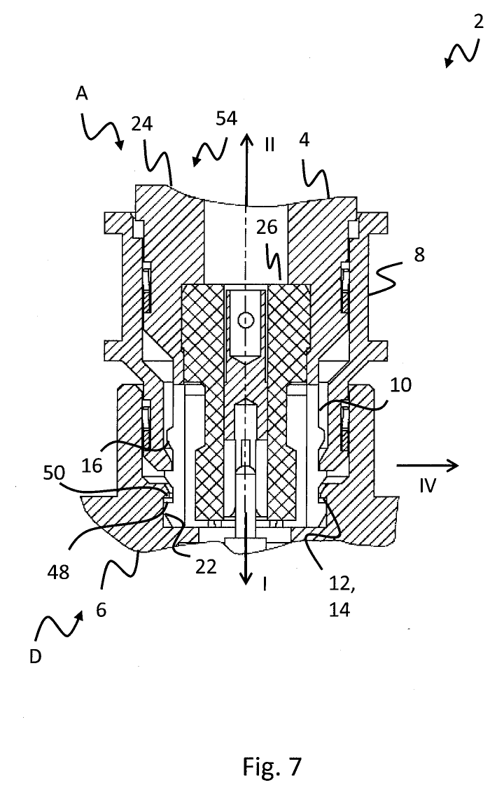

FIG. 7 shows a fifth step in which, through continuation of the joining movement in the first direction I, the first connector 4 finally reaches its end position in which the front end D of the first connector 4 makes contact with a base of the second connector 6 and, due to the resilient design, has moved back in the fourth direction IV opposite to the third direction III. As a result, the contact of the outer conductor 54 is now formed in the mating contact section 22.

A meeting of a contact surface 48 of the snap-in hook 38 (see FIG. 2) with a mating contact surface 50 of the counter-snap-in hook 40 (see FIG. 1) prevents the first connector 4 from being separated again through a movement in the direction of the second direction II, i.e. contrary to the joining movement. In the present exemplary embodiment, the snap-in hooks 38 and the counter-snap-in hooks 40 are designed such that a tensile force in the direction of the second direction II in an amount of for example 500 N is necessary in order to separate the first connector 4 from the second connector 6.

During steps one to five, the securing element 8 remains in the locking position A and does not impede the deflecting movements of the contact tongues 30 (see FIG. 2), i.e., it allows sufficient space for their deflecting movements.

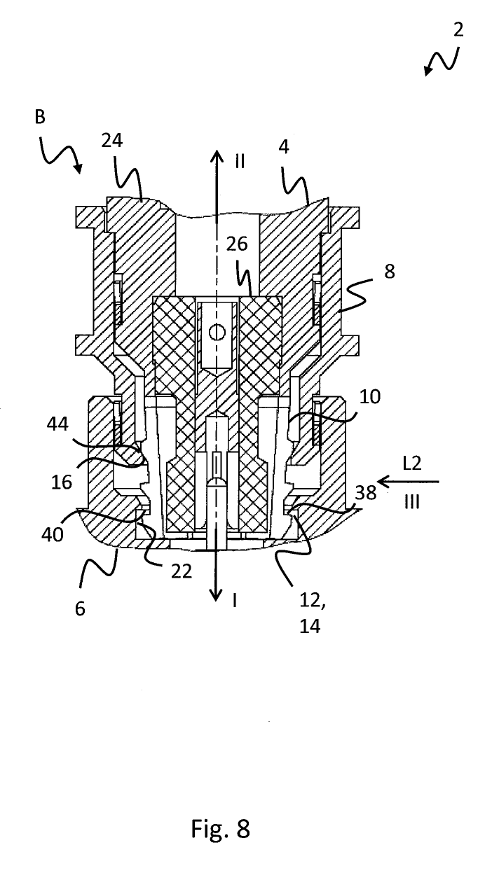

FIG. 8 shows a further step in which the securing element 8 has been displaced from the locking position A into the unlocking position B through a movement in the second direction II.

As a result of this displacement, the withdrawal contact surface 44 has come into contact with the withdrawal bevel 16, wherein as a result of the ramp-formed design of the withdrawal bevel 16 the contact tongues 30 (see FIG. 2) are deflected by a second travel length L2 in the direction of the third direction III. The second travel length L2 is thereby greater than the first travel length L1, so that the snap-in hook 38 and the counter-snap-in hook 40 are no longer in contact with one another or are out of engagement. The first connector 4 can now be separated from the second connector 6 without any problem, with little expenditure of force.

Thus, a plug connector 2 is provided in which it is not necessary, before performing a joining movement in order to connect the first connector 4 with the second connector 6, first to move the securing element 8 in a direction contrary to the direction of the joining movement in the first direction I; instead, the first connector 4 can be connected with the second connector 6 immediately, in one step. This greatly simplifies the creation of a connection with the plug connector 2 and permits single-handed assembly. At the same time the plug connector 2 has fixing elements 10 which, through a snap-locking connection of the first connector 4 with the second connector 6, maintain the connection between the first connector 4 and the second connector 6 even under the application of high tensile forces e.g. above between 22 and 68 N, for example 500 N.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A plug connector comprising a first connector and a second connector,
wherein the first connector and the second connector can be connected through a joining movement along a main axis of extension of the plug connector,
wherein a securing element which is associated with the first connector can be displaced along the main axis of extension between a locking position (A) and an unlocking position (B),
wherein a fixing element is provided in order to fix the first connector to the second connector through interaction with a counter-fixing element in order to block a disconnecting movement,
wherein the fixing element is moveable in a radial direction (III),
wherein the securing element is, directly or indirectly, in operative connection with the fixing element, such that a displacement of the securing element from the locking position (A) into the unlocking position (B) causes a displacement of the fixing element at least in a radial direction (III), and wherein, by displacing the securing element from the locking position (A) into the unlocking position (B), the fixing element of the counter-fixing element can be released through a movement in a radial direction (III) in order to permit a disconnecting movement in an axial direction (II) in order to separate the first connector from the second connector,
such that in the locking position (A) the securing element is designed to permit the fixing element a movement in a radial direction (III) in order to make possible a joining movement in an axial direction (I) in order to connect the first connector with the second connector.

2. The plug connector of claim 1, wherein in the locking position (A) the fixing element can be moved by a first travel length (L1), at least in a radial direction (III), and by displacing the securing element from the locking position (A) into the unlocking position (B) the fixing element can be displaced in a radial direction (III) by a second travel length (L2), wherein the second travel length (L2) is greater than the first travel length (L1).

3. The plug connector of claim 1, wherein the fixing element has a snap-in hook and the counter-fixing element has a counter-snap-in hook designed to interact with the snap-in hook in order to form a snap-locking connection.

4. The plug connector of claim 1, wherein a first insertion region and a second insertion region are provided, wherein the second insertion region is designed such that, through interaction with the first insertion region, this causes the movement of the fixing element in a radial direction (III), wherein, in particular,
the first insertion region is associated with the first connector and the second insertion region is associated with the second connector.

5. The plug connector of claim 1, wherein the securing element and/or the fixing element is manufactured from an electrically conductive material.

6. The plug connector of claim 5, wherein the securing element is connected with an outer conductor of the plug connector in an electrically conductive manner via at least one shield contact element.

7. The plug connector of claim 1, wherein a withdrawal bevel which is at least partially in operative connection with the securing element is provided which, through interaction with a withdrawal contact surface, causes the movement of the fixing element in the direction of the third direction (III).

8. The plug connector of claim 7, wherein the withdrawal bevel and the withdrawal contact surface are associated with the first connector.

9. The plug connector of claim 8, wherein the withdrawal bevel is formed on the fixing element.

10. The plug connector of claim 8, wherein the withdrawal contact surface is formed on the securing element.

11. The plug connector of claim 1, wherein the securing element is connected undetachably with a main plug body of the first connector.

12. The plug connector of claim 1, wherein the securing element comprises a securing sleeve.

13. A first connector for a plug connector comprising:
a joining movement connecting the first connector to a second connector along a main axis of extension of the plug connector;
a securing element which is associated with the first connector displaced along the main axis of extension between a locking position (A) and an unlocking position (B); and
a fixing element fixing the first connector to the second connector through interaction with a counter-fixing element in order to block a disconnecting movement;
wherein the fixing element is moveable in a radial direction (III);
wherein the securing element is, directly or indirectly, in operative connection with the fixing element, such that a displacement of the securing element from the locking position (A) into the unlocking position (B) causes a displacement of the fixing element at least in a radial direction (III), and wherein, by displacing the securing element from the locking position (A) into the unlocking position (B), the fixing element of the counter-fixing element can be released through a movement in a radial direction (III) in order to permit a disconnecting movement in an axial direction (II) in order to separate the first connector from the second connector, such that in the locking position (A) the securing element is designed to permit the fixing element a movement in a radial direction (III) in order to make possible a joining movement in an axial direction (I) in order to connect the first connector with the second connector.

14. A second connector for a plug connector comprising:
a joining movement connecting the second connector to a first connector along a main axis of extension of the plug connector;
a securing element associated with the first connector displaceable along the main axis of extension between a locking position (A) and an unlocking position (B); and
a fixing element fixing the second connector to the first connector through interaction with a counter-fixing element in order to block a disconnecting movement;
wherein the fixing element is moveable in a radial direction (III);
wherein the securing element is, directly or indirectly, in operative connection with the fixing element, such that a displacement of the securing element from the locking position (A) into the unlocking position (B) causes a displacement of the fixing element at least in a radial direction (III), and wherein, by displacing the securing element from the locking position (A) into the unlocking position (B), the fixing element of the counter-fixing element can be released through a movement in a radial direction (III) in order to permit a disconnecting movement in an axial direction (II) in order to separate the first connector from the second connector, such that in the locking position (A) the securing element is designed to permit the fixing element a movement in a radial direction (III) in order to make possible a joining movement in an axial direction (I) in order to connect the first connector with the second connector.

15. A satellite equipped with a plug connector, said plug connector comprising:
a first connector and a second connector,
wherein the first connector and the second connector can be connected through a joining movement along a main axis of extension of the plug connector,
wherein a securing element which is associated with the first connector can be displaced along the main axis of extension between a locking position (A) and an unlocking position (B),
wherein a fixing element is provided in order to fix the first connector to the second connector through interaction with a counter-fixing element in order to block a disconnecting movement,
wherein the fixing element is moveable in a radial direction (III),
wherein the securing element is, directly or indirectly, in operative connection with the fixing element, such that a displacement of the securing element from the locking position (A) into the unlocking position (B) causes a displacement of the fixing element at least in a radial direction (III), and wherein, by displacing the securing element from the locking position (A) into the unlocking position (B), the fixing element of the counter-fixing element can be released through a movement in a radial direction (III) in order to permit a disconnecting movement in an axial direction (II) in order to separate the first connector from the second connector,
such that in the locking position (A) the securing element is designed to permit the fixing element a movement in a radial direction (III) in order to make possible a joining movement in an axial direction (I) in order to connect the first connector with the second connector.

16. The plug connector of claim 3, wherein a first insertion region and a second insertion region are provided, wherein the second insertion region is designed such that, through interaction with the first insertion region, this causes the movement of the fixing element in a radial direction (III), wherein, in particular, the first insertion region is associated with the first connector and the second insertion region is associated with the second connector.

17. The plug connector of claim 4, wherein a withdrawal bevel which is at least partially in operative connection with the securing element is provided which, through interaction with a withdrawal contact surface, causes the movement of the fixing element in the direction of the third direction (III).

18. The plug connector of claim 16, wherein a withdrawal bevel which is at least partially in operative connection with the securing element is provided which, through interaction with a withdrawal contact surface, causes the movement of the fixing element in the direction of the third direction (III).

19. The plug connector of claim 9, wherein the withdrawal contact surface is formed on the securing element.
